(19) United States
(12) Patent Application Publication
(10) Pub. No.: US 2025/0097780 A1
(43) Pub. Date: Mar. 20, 2025

(54) METHOD AND APPARATUS FOR ACCESSING A RANDOM ACCESS CHANNEL BY SELECTIVELY USING DEDICATED OR CONTENTION-BASED PREAMBLES

(71) Applicant: InterDigital Patent Holdings, Inc., Wilmington, DE (US)

(72) Inventors: Guodong Zhang, Woodbury, NY (US); Jin Wang, Princeton, NJ (US)

(73) Assignee: InterDigital Patent Holdings, Inc., Wilmington, DE (US)

(21) Appl. No.: 18/968,433

(22) Filed: Dec. 4, 2024

Related U.S. Application Data
(63) Continuation of application No. 18/224,213, filed on Jul. 20, 2023, now Pat. No. 12,192,830.
Application No. 18/224,213 is a continuation of application No. 17/478,381, filed on Sep. 17, 2021, now Pat. No. 11,751,104.
Application No. 17/478,381 is a continuation of application No. 16/444,736, filed on Jun. 18, 2019, now Pat. No. 11,134,417.
Application No. 16/444,736 is a continuation of application No. 15/977,706, filed on May 11, 2018, now Pat. No. 10,368,270.
Application No. 15/977,706 is a continuation of application No. 15/067,607, filed on Mar. 11, 2016, now Pat. No. 10,021,601.
Application No. 15/067,607 is a continuation of application No. 14/169,951, filed on Jan. 31, 2014, now Pat. No. 9,344,919.
Application No. 14/169,951 is a continuation of application No. 12/392,235, filed on Feb. 25, 2009, now Pat. No. 8,649,353.
(60) Provisional application No. 61/033,676, filed on Mar. 4, 2008.

(51) Int. Cl. H04W 36/00; H04W 36/08; H04W 74/00; H04W 74/08; H04W 74/0833; H04W 88/08

(52) U.S. Cl. CPC H04W 36/0005; H04W 74/004; H04W 74/0833; H04W 74/0866; H04W 36/08; H04W 88/08

(57) ABSTRACT

A method and apparatus for accessing a random access channel (RACH) during handover are disclosed. A handover procedure is initiated and a maximum handover interruption timer is activated. A dedicated preamble is transmitted in an attempt to access the RACH on a condition that the dedicated preamble is reserved in a current random access opportunity and the maximum handover interruption timer has not expired. A contention-based preamble is transmitted in an attempt to access the RACH on a condition that a dedicated preamble is not reserved in a current random access opportunity. If the maximum handover interruption timer has expired, a contention-based preamble is transmitted in an attempt to access the RACH.

### CROSS REFERENCE TO RELATED APPLICATIONS

This application claims the benefit of U.S. Provisional Application No. 61/033,676 filed Mar. 4, 2008, which is incorporated by reference as if fully set forth.

### FIELD OF INVENTION

This application is related to wireless communications.

### BACKGROUND

In a Third Generation Partnership Project (3GPP) Long Term Evolution (LTE) wireless communication system, when a wireless transmit/receive unit (WTRU) performs handover to a target cell, the WTRU uses a dedicated preamble to access a network. A preamble is a signal sent from the WTRU to an evolved Node-B (eNB) to detect timing misalignment in the uplink (UL) during a handover procedure. Accordingly, the target cell needs to reserve a dedicated preamble for the WTRU. However, a non-contention based random access channel (RACH), used by the eNB to provide configuration information of the dedicated preamble, will become overloaded when a large number of WTRUs handover to the same target cell in a short amount of time. Because of this overloading of the RACH, there is a need for a more efficient mechanism by which the dedicated preamble is used during handover.

### SUMMARY

The method and apparatus disclosed herein allows for an efficient usage of a dedicated preamble to access a RACH in evolved universal terrestrial radio access (E-UTRA) during handover. The WTRU may use a dedicated preamble in pre-reserved (or preconfigured) frames, but not in every frame. Alternatively, the WTRU may use contention-based preambles in other random access opportunities when a dedicated preamble is not reserved, or a RACH access attempt does not succeed using the dedicated preamble.

### BRIEF DESCRIPTION OF THE DRAWINGS

A more detailed understanding may be had from the following description, given by way of example in conjunction with the accompanying drawings wherein:

FIG. 1 shows an example of a plurality of WTRUs sharing one dedicated preamble during different reserved dedicated preamble periods;

FIG. 2 is a block diagram of a wireless communication system including a WTRU and an eNB; and

FIG. 3 is a flowchart of a procedure for using a dedicated or contention-based preamble during handover using the system of FIG. 2.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to an evolved Node-B (eNB), a site controller, an access point (AP), or any other type of interfacing device capable of operating in a wireless environment.

The method and apparatus disclosed herein allows for an efficient usage of a dedicated preamble for handover performed by WTRUs in E-UTRA. The WTRU may use a dedicated preamble in pre-reserved (or preconfigured) frames, but not in every frame. Alternatively, the WTRU may use contention-based preambles in other random access opportunities when a dedicated preamble is not reserved.

Rather than reserving a dedicated preamble for a handover WTRU in every random access opportunity, (e.g., every 10 ms), the eNB will reserve a dedicated preamble N out of M random access opportunities, where the parameter M is defined as the period of a reserved dedicated preamble. A random access opportunity is a time period when a RACH may be accessed. In such an instance, the preferred value of N is one.

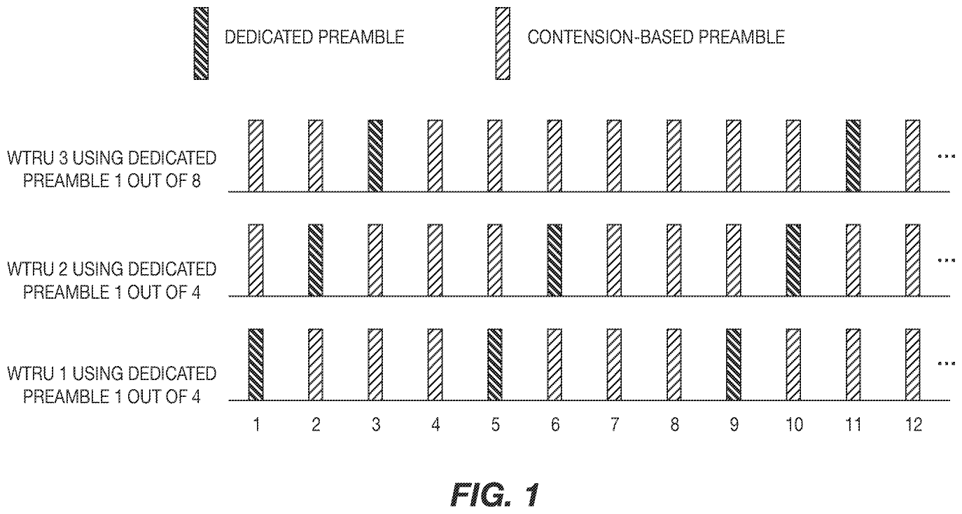

As is shown in FIG. 1, such a value facilitates the eNB to interleave several WTRUs sharing one dedicated preamble over the time domain. WTRU 1 only uses the dedicated preamble in a first random access opportunity out of every 4 random access opportunities. WTRU 2 only uses the dedicated preamble in a second random access opportunity out of every 4 random access opportunities. WTRU 3 only uses the dedicated preamble in a third random access opportunity out of every 8 random access opportunities. Thus, a dedicated preamble is efficiently shared by 3 WTRUs in the time domain.

The network will monitor and decide the value of parameters N and M based on the load on a non-contention RACH. Although different M values may be configured, a larger period must be an integer multiple of a smaller preamble period. In this way, WTRUs with different dedicated preamble configurations may share the same preamble without collision in the time domain. An example of a preferred set of a different reserved dedicated preamble periods is M=1, 2, 4 and 8.

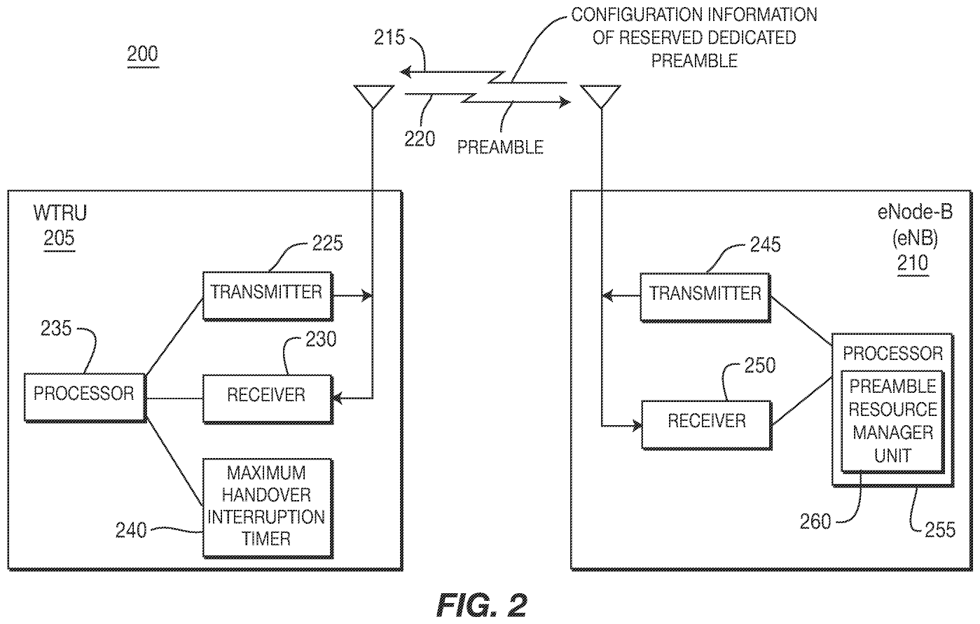

FIG. 2 shows a wireless communication system 200 including a WTRU 205 and an eNB 210. The eNB 210 reserves a dedicated preamble for a WTRU N out of M random access opportunities for a duration up to a maximum allowed handover interruption time. The eNB 210 may transmit reserved dedicated preamble configuration information 215 to the WTRU 205 via a handover command, when a handover decision is made, or via a special medium access control (MAC) protocol data unit (PDU). The WTRU 205 includes a transmitter 225, a receiver 230 which receives preambles from the WTRU 205, a processor 235 and a maximum handover interruption timer 240. The eNB 110 includes a transmitter 245, which is configured to transmit the reserved dedicated preamble configuration information 215, a receiver 250 which receives the preambles from the WTRU 205 and a processor 255. The processor 255 includes a preamble resource manager 260, which is used to allocate preambles to the WTRU 205.

The WTRU 205 transmits either a dedicated or contention-based preamble 220 to the eNB 210 such that the WTRU 205 can access a RACH to complete a handover procedure. If a RACH access attempt implemented by the WTRU 205 fails when using a dedicated preamble, the WTRU 205 will then use a contention-based preamble in subsequent random access opportunities until either its RACH access attempt succeeds or a random access opportunity occurs in which there is a reserved dedicated preamble.

Still referring to FIG. 2, the WTRU 200 is configured to access a RACH during handover. The processor 235 is configured to initiate handover and activate the maximum handover interruption timer 240. The transmitter is configured to transmit a dedicated preamble in an attempt to access the RACH on a condition that the dedicated preamble is reserved in a current random access opportunity and the maximum handover interruption timer has not expired, and transmit a contention-based preamble in an attempt to access the RACH on a condition that a dedicated preamble is not reserved in a current random access opportunity.

The transmitter 225 in the WTRU 200 is also configured to transmit a contention-based preamble in an attempt to access the RACH on a condition that the maximum handover interruption timer has expired. The transmitter 225 is also configured to transmit, on a condition that a failure to access a RACH has failed, a contention-based preamble in subsequent random access opportunities until a successful RACH access attempt occurs, or a random access opportunity occurs in which there is a reserved dedicated preamble.

A non-contention based procedure is used on a condition that the dedicated preamble is reserved in a current random access opportunity and the maximum handover interruption timer has not expired.

A contention-based random access procedure is used on a condition that the dedicated preamble is not reserved in a current random access opportunity and the maximum handover interruption timer has expired.

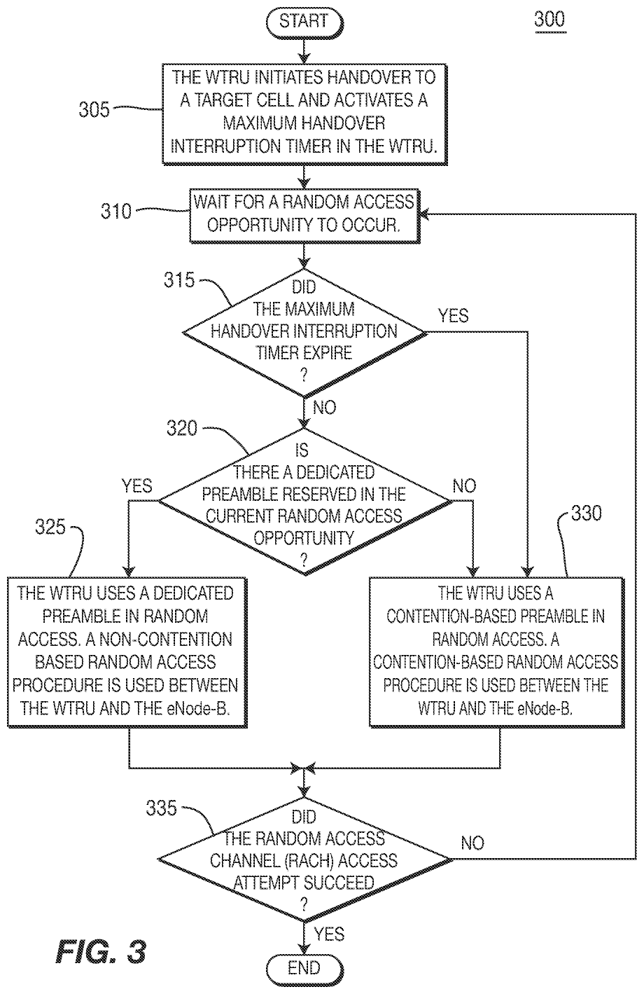

FIG. 3 is a flow diagram of a procedure 300 that uses a reserved dedicated preamble or a contention-based random access preamble during handover. Referring to FIGS. 2 and 3, the processor 235 in the WTRU 205 initiates a handover to a target cell and activates the maximum handover interruption timer 240 in the WTRU 205 (305). When a random access opportunity occurs (310), a determination is made by the processor 235 as to whether the maximum handover interruption timer 240 has expired (315). If the maximum handover interruption timer 240 has not yet expired before a random access opportunity occurs, the processor 235 determines whether there is a dedicated preamble reserved in the current random access opportunity (step 320).

If there is a reserved dedicated preamble in the current random access opportunity, the WTRU uses a dedicated preamble in random access, and a non-contention based random access procedure is used between the WTRU 205 and the eNB 210 to make a RACH access attempt (step 325). A non-contention based random access procedure is two-step random access procedure that does not involve transmission of RACH message 3 in the uplink and contention resolution in the downlink, (as compared to a contention-based one).

If a reserved dedicated preamble does not exist in the current random access opportunity, the WTRU uses a contention-based preamble in random access, and a contention based random access procedure is used between the WTRU 205 and the eNB 210 to make a RACH access attempt (step 330). A contention based random access procedure is a four-step random access procedure that involves transmission of RACH message 3 in the uplink and contention resolution in the downlink. The contention-based preamble may be randomly selected from a set of contention-based preambles.

In step 335, a determination is made as to whether the RACH access attempt succeeded. If a WTRU fails its RACH access attempt using a reserved dedicated preamble, it will use a contention-based preamble in subsequent random access opportunities until either its RACH access attempt succeeds, or a random access opportunity occurs in which there is a reserved dedicated preamble.

Due to the high success probability of RACH access using a dedicated preamble, the approach to try a RACH access attempt with alternating non-contention based and contention based RACH access attempts is preamble resource efficient.

Although the features and elements of the present method and apparatus are described in particular combinations, each feature or element may be used alone, without other features and elements of the preferred embodiments, or in various combinations with or without other features and elements of the present method and apparatus.

While the present method and apparatus has been described in terms of the preferred embodiment, other variations which are within the scope of the invention will be apparent to those skilled in the art.

Although features and elements are described above in particular combinations, each feature or element may be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a WTRU, user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

* * *

What is claimed is:

1. A base station configured to manage random access of wireless transmit/receive units (WTRUs) in a cell, the base station comprising:
a transmitter configured to:
transmit preamble configuration information including an indication of a dedicated preamble and a dedicated preamble period, wherein the dedicated preamble is used for random access in the cell during available random access channel (RACH) opportunities of the dedicated preamble period; and
transmit a first dedicated preamble reservation to a first WTRU, wherein the first dedicated preamble reservation indicates a first subset of the available RACH opportunities of the dedicated preamble period during which the dedicated preamble is reserved for the first WTRU.

2. The base station of claim 1, further comprising:
a receiver configured to receive the dedicated preamble from the first WTRU during a RACH opportunity selected from the first subset of the available RACH opportunities of the dedicated preamble period.

3. The base station of claim 1, wherein the transmitter is further configured to:
transmit a second dedicated preamble reservation to a second WTRU, wherein the second dedicated preamble reservation indicates a second subset of the available RACH opportunities of the dedicated preamble period different than the first subset during which the dedicated preamble is reserved for the second WTRU.

4. The base station of claim 3, further comprising:
a receiver configured to receive the dedicated preamble from the second WTRU during a RACH opportunity selected from the second subset of the available RACH opportunities of the dedicated preamble period.

5. The base station of claim 1, wherein the available RACH opportunities of the dedicated preamble period is an integer M number of RACH opportunities and the subset of the available RACH opportunities of the dedicated preamble period is an integer N number of RACH opportunities, wherein N is less than M.

6. The base station of claim 1, wherein the preamble configuration information is common to all WTRUs of the cell, and wherein the first dedicated preamble reservation is only for the first WTRU.

7. The base station of claim 3, wherein the preamble configuration information is common to all WTRUs of the cell, and wherein the second dedicated preamble reservation is only for the second WTRU.

8. A method implemented in a wireless transmit/receive unit (WTRU) for random access during handover from a source base station to a target base station, the method comprising:
receiving, from the source base station, a handover command, the handover command having dedicated preamble configuration information including an indication of a dedicated preamble, a dedicated preamble period, and a dedicated preamble reservation, wherein the dedicated preamble is used for contention free random access in a cell during available random access channel (RACH) opportunities of the dedicated preamble period, and wherein the dedicated preamble reservation indicates a subset of the available RACH opportunities of the dedicated preamble period during which the dedicated preamble is reserved for the WTRU;
initiating a timer in response to the handover command;
transmitting, to the target base station on a condition that the timer has not expired, the indicated dedicated preamble during a RACH opportunity selected from the indicated RACH opportunities for the dedicated preamble based on the dedicated preamble reservation; and
transmitting, to the target base station subsequent to expiration of the timer and on a condition that RACH access using the dedicated preamble was not successful, a contention based preamble during a RACH opportunity selected from RACH opportunities for the contention based preamble.

9. The method of claim 8, wherein the transmitting the indicated dedicated preamble further includes transmitting the indicated dedicated preamble interleaved over the time domain with at least one other WTRU.

10. The method of claim 8, wherein the indicated dedicated preamble is not reserved for the WTRU in every frame.

11. A wireless transmit/receive unit (WTRU) configured for random access during handover from a source base station to a target base station, the WTRU comprising:
a receiver configured to receive, from the source base station, a handover command, the handover command having dedicated preamble configuration information including an indication of a dedicated preamble, a dedicated preamble period, and a dedicated preamble reservation, wherein the dedicated preamble is used for contention free random access in a cell during available random access channel (RACH) opportunities of the dedicated preamble period, and wherein the dedicated preamble reservation indicates a subset of the available RACH opportunities of the dedicated preamble period during which the dedicated preamble is reserved for the WTRU;
a timer configured to initiate in response to the handover command; and
a transmitter configured to:
transmit, to the target base station on a condition that the timer has not expired, the indicated dedicated preamble during a RACH opportunity selected from the indicated RACH opportunities for the dedicated preamble based on the dedicated preamble reservation; and
transmit, to the target base station subsequent to expiration of the timer and on a condition that RACH access using the dedicated preamble was not successful, a contention based preamble during a RACH opportunity selected from RACH opportunities for the contention based preamble.

12. The WTRU of claim 11, wherein the transmitter is further configured to transmit, on a condition that the timer has not expired, the indicated dedicated preamble interleaved over the time domain with at least one other WTRU.

13. The WTRU of claim 11, wherein the indicated dedicated preamble is not reserved for the WTRU in every frame.

14. A communication station configured to manage random access of a wireless transmit/receive unit (WTRU), the communication station comprising:
a transmitter configured to:
transmit preamble configuration information including an indication of a preamble and a preamble period, wherein the preamble is used for random access by the WTRU during a random access channel (RACH) opportunity of the preamble period, wherein the preamble period spans a plurality of RACH opportunities; and
transmit a preamble reservation to the WTRU, wherein the preamble reservation indicates a subset of the plurality of RACH opportunities during which the preamble is reserved for the WTRU.

15. The communication station of claim 14, further comprising:
a receiver configured to receive the preamble from the WTRU during a RACH opportunity selected from the subset of the plurality of RACH opportunities.

16. The communication station of claim 14, wherein the plurality of RACH opportunities is an integer M number of RACH opportunities and the subset of the plurality of RACH opportunities is an integer N number of RACH opportunities, wherein N is less than M.

17. The communication station of claim 14, wherein the preamble configuration information is common to all WTRUs in communication with the communication station, and wherein the preamble reservation is only for the WTRU.
